(19) United States
(12) Patent Application Publication
(10) Pub. No.: US 2006/0092297 A1
(43) Pub. Date: May 4, 2006

(54) Method and apparatus for removing hot pixels in a digital camera

(75) Inventors: Seok-goun Lee, Seongnam-si (KR); Jong-hwan Lee, Seoul (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/071,906

(22) Filed: Mar. 4, 2005

(30) Foreign Application Priority Data
Nov. 1, 2004 (KR) 10-2004-0087799

(51) Int. Cl. H04N 5/213

(52) U.S. Cl. 348/241

(57) ABSTRACT

An apparatus and method of removing fixed pattern noise in a digital camera are provided. The apparatus includes a signal processing unit that calculates location information of the fixed pattern noise from a dark image photographed using an ISO and exposure time that are different from an ISO and exposure time used to photograph a general image, and removes the fixed pattern noise from the general image using the location information. The fixed pattern noise can be effectively removed while reducing the total photographing time in comparison to conventional apparatuses and methods.

### BACKGROUND OF THE INVENTION

This application claims the priority of Korean Patent Application No. 10-2004-0087799, filed on Nov. 1, 2004 in the Korean Intellectual Property Office, the disclosure of which is incorporated herein in its entirety by reference.

1. Field of the Invention

The present invention relates to methods and apparatuses for operating a digital camera, and more particularly, to methods and apparatuses for removing hot pixels from a photographic image in which a dark frame is taken using an ISO and an exposure time that are different from that used in the photographic image.

2. Description of the Related Art

Digital imaging devices such as digital cameras and digital camcorders use charged coupled devices (CCDs) in place of film. A CCD is a sensor that converts light into electric signals. It has a silicon chip with minute photodiodes disposed on top of it. These photodiodes are organized into numerous “pixels” on top of the silicon chip in a checkered pattern. Each pixel of the CCD captures light that is eventually converted into one “pixel” of an image.

CCDs are sensitive to heat. As a result, heat noise is frequently generated when a CCD operates, which prevents a cell from accurately generating the color for its pixel. Pixels generated by CCDs as a result of this heat noise are called hot pixels. Hot pixels usually show up at a fixed location for a short period of time. That is why hot pixels are also called “fixed pattern noise.” Fixed pattern noise frequently occurs when the shutter of a digital camera is open for a long period of time, and it hinders the smooth reproduction of an image.

FIG. 1 is a flow chart illustrating a conventional method of removing fixed pattern noise. First, an image frame (Frame 1) is photographed according to a set CCD sensitivity (ISO) and exposure time (100). The image frame (Frame 1), including the fixed pattern noise, is stored in a memory (not shown) (102). Then, a so-called “dark frame” (Frame 2) is photographed using the same ISO and exposure time as the photographed image frame (Frame 1) (104). A dark frame (such as Frame 2) is an image photographed with the shutter manually closed to physically block all light from reaching the CCD. The dark frame (Frame 2) is not affected by light but does include the fixed pattern noise.

The same exposure time is used when photographing the image frame (Frame 1) and the dark frame (Frame 2), so as to accurately reproduce the fixed pattern noise of in the image frame (Frame 1) on the dark frame (Frame 2). Ideally, the same number n hot pixels will occur on both the image frame (Frame 1) and the dark frame (Frame 2).

The photographed dark frame (Frame 2) is then stored in the memory (106). Frame subtraction is then performed to remove the fixed pattern noise. That is, the dark frame (Frame 2) is subtracted from the image frame (Frame 1) (108). Through such frame subtraction, a new image frame (Frame 3) with the fixed pattern noise removed is generated. The new image frame (Frame 3) is then corrected by image processing, and an image file (e.g., JPEG) is generated (110).

The method illustrated in FIG. 1 the total photographing time is more than twice the set exposure time of the digital image processing apparatus. For example, referring to FIG. 6A (which illustrates the total photographing time of a conventional digital image processing apparatus) if the exposure time is 10 seconds, \textcircled{1} the image frame (Frame 1) is photographed for 10 seconds, \textcircled{2} the dark frame (Frame 2) is photographed for 10 seconds, \textcircled{3} the noise removal after frame subtraction takes s1 seconds, and \textcircled{4} the post-processing of the frame subtraction takes s2 seconds. Consequently, the total photographing time (\textcircled{1}+\textcircled{2}+\textcircled{3}+\textcircled{4}) is more than twice the exposure time, that is, more than 20 seconds. Thus, it can be seen that there is a need for a new method and apparatus for removing noise from a digital image that avoids the foregoing problems.

### SUMMARY OF THE INVENTION

The present invention provides a method and apparatus for removing fixed pattern noise in a digital camera that removes fixed pattern noise while reducing the total photographing time by photographing a dark image with greater sensitivity and shorter exposure time than an original image and removing the fixed pattern noise from the original image by calculating location information of the fixed pattern noise from the dark image.

According to an embodiment of the invention, an apparatus comprises a signal processing unit that receives signals representing a first photograph, in which the first photograph was taken at first ISO and at a first exposure time. The apparatus also receives signals representing a second photograph, in which the second photograph is a dark image photographed at a second ISO and at a second exposure time, the second ISO being different from the first ISO, and the second exposure time being different from the first exposure time. The signal processing unit analyzes the dark image, calculates the location of the fixed pattern noise based on the analysis, and removes the fixed pattern noise from the photograph using the calculated location.

In various embodiments of the invention, the second photograph is photographed using an ISO that is N times the ISO used to photograph the first photograph, and using an exposure time that is 1/N the exposure time used to photograph the general image.

In another embodiment of the invention, a method of removing fixed pattern noise in a digital camera, comprises photographing a main image using a first ISO and a first exposure time; photographing a dark image using a second ISO and a second exposure time, wherein the second ISO is different from the first ISO, and the second exposure time is different from the first exposure time; determining the location of the fixed pattern noise in the dark image; using the determined location to remove the fixed pattern noise from the general image.

In yet another embodiment of the invention, a method for removing fixed pattern noise comprises setting the digital camera to a first ISO and a first exposure time; opening a shutter of a digital camera to permit light to enter the digital camera; receiving the light with a charge-coupled device; capturing a first image with the charge-coupled device; setting the digital camera to a second ISO and a second exposure time; closing the shutter to prevent light from entering the digital camera; capturing a second image with the charge-coupled device while the shutter is closed; determining, using a digital signal processor, the location of the fixed pattern noise on the second image; altering the content of the first image at a location on the first image that matches the determined location on the second image, thereby removing the fixed pattern noise from the first image; and displaying the first image on a display panel.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart illustrating a conventional method of removing hot pixels;

FIG. 2 is a front perspective view of a digital camera according to an embodiment of the present invention;

FIG. 3 is a rear view of the digital camera of FIG. 2;

FIG. 4 is a block diagram of the digital camera of FIGS. 2 and 3;

FIG. 5 is a block diagram of an apparatus for removing fixed pattern noise in the digital camera according to an embodiment of the present invention;

FIGS. 6A and 6B illustrates total photographing times of a conventional digital camera and a digital camera according an embodiment of the present invention; and

FIG. 7 is a flow chart illustrating a method of removing fixed pattern noise in a digital camera according to an embodiment of the present invention.

### DETAILED DESCRIPTION OF THE INVENTION

The present invention will now be described more fully with reference to the accompanying drawings, in which embodiments of the invention are shown.

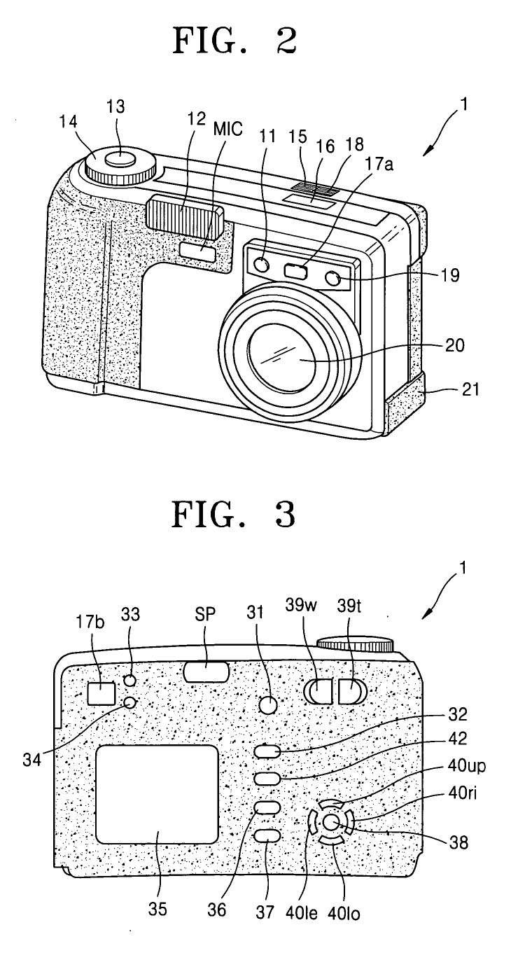

Referring to FIG. 2, a digital image processing apparatus 1 includes a microphone MIC, a self-timer lamp 11, a flash 12, a view finder 17a, a flash light amount sensor (FS) 19, and a lens unit 20 on its front; a shutter 13, a mode dial 14, a function-select button 15, a photograph-information displaying unit 16, and a function-block button 18 on its top; and an external interface 21 on its side.

The self-timer lamp 11 operates from a time when the shutter 13 is pressed until the shutter 13 starts operating in a self-timer mode. The mode dial 14 is used by a user to select various operating modes, such as a still image photographing mode, a night scene photographing mode, a moving picture photographing mode, a play mode, a computer connecting mode, and a system setting mode. The function-select button 15 is used by the user to select one of, for example, a still image photographing mode, a night scene photographing mode, a moving picture photographing mode, and a play mode of the digital image processing apparatus 1.

The photograph-information displaying unit 16 displays information on each photographing function. The function-block button 18 is used by the user to select one of the functions displayed on the photograph-information displaying unit 16.

Referring to FIG. 3, the back of the digital image processing apparatus 1a includes a speaker SP, a power button 31, a monitor button 32, an automatic focus lamp 33, a view finger 17b, a flash standby lamp 34, a display panel 35 (e.g., a liquid crystal display (LCD)), an exposure compensation/delete button 36, an enter/play button 37, a menu/OK button 38, a wide-angle zoom button 39w, a telephoto zoom button 39t, an up-movement button 40up, a right-movement button 40ri, a down-movement button 40lo, a left-movement button 40le, and a playback button 42.

The monitor button 32 is used by the user to control the operation of the display panel 35. For example, if the user presses the monitor button 32 a first time, an image of a subject (i.e. the physical scene being viewed and photographed by the user) and photographing information for the image are displayed on the display panel 35, if the monitor button 32 is pressed a second time, only the image of the subject is displayed on the display panel 35, and if the monitor button 32 is pressed a third time, power supplied to the display panel 35 is cut off.

The automatic focus lamp 33 operates when an automatic focusing operation is completed. The flash standby lamp 34 operates when the flash 12 (see FIG. 2) is on standby. The exposure compensation/delete button 36 controls the amount of light when the digital image processing apparatus 1 is manually operated, or is used as a delete button when the user is setting the operating mode.

The enter/play button 37 is used by the user to input data or perform various functions, such as stop or play in the play mode. The menu/OK button 38 is used to display and select a menu of a mode selected by the mode dial 14. The up-movement button 40up, the right-movement button 40ri, the down-movement button 40lo, and the left-movement button 40le are used by a user to select the modes and to change displayed region of the image displayed on the display panel 35. The playback button 42 is used to check and reproduce the last photographed image, moving picture, or audio information.

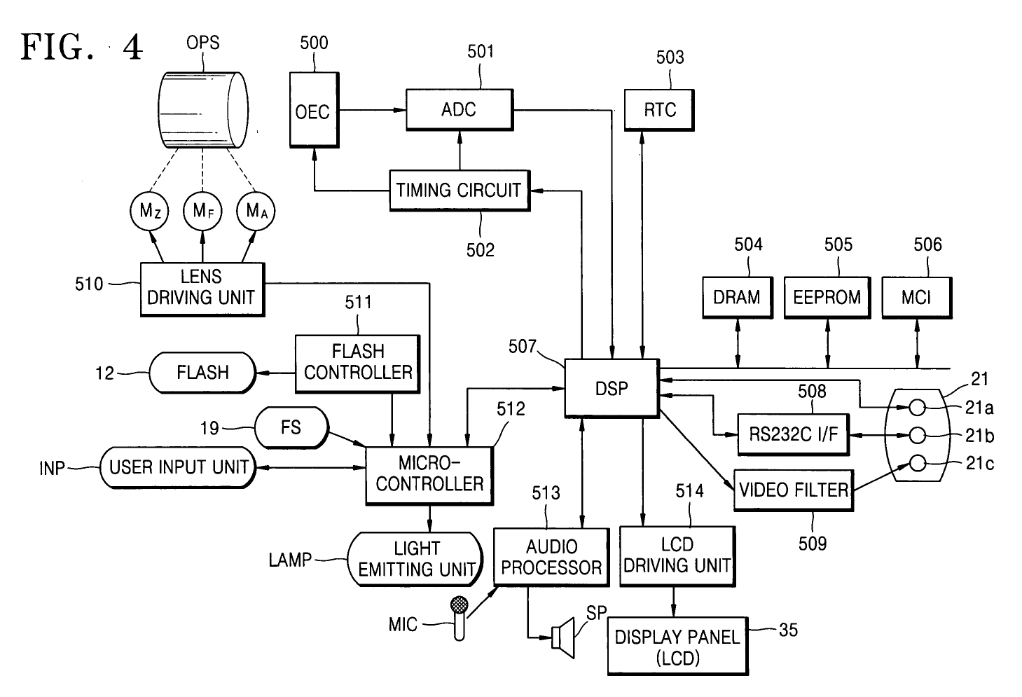

Referring to FIG. 4 the digital image processing apparatus 1 (from FIGS. 2 and 3) includes an optical system OPS. The optical system OPS includes the lens unit 20 from FIG. 2, and optically processes light reflected from a subject. The lens unit 20 of the optical system OPS includes a zoom lens, a focus lens, and a compensation lens (not shown).

If a user presses the wide-angle zoom button 39w (see FIG. 3) or the telephoto zoom button 39t (see FIG. 3), a signal corresponding to the wide-angle zoom button 39w or the telephoto zoom button 39t is input to a micro-controller 512. Accordingly, the micro-controller 512 controls a lens driving unit 510, which drives a zoom motor M_{Z}, which, in turn, moves the zoom lens. That is, if the wide-angle zoom button 39w is pressed, the focal length of the zoom lens is shortened, thus increasing the viewing angle. Conversely, if the telephoto zoom button 39t is pressed, the focal length of the zoom lens is lengthened, thus decreasing the viewing angle. Referential character M_{A} denotes a motor to drive an aperture (not shown).

Referring still to FIG. 4, the digital image processing apparatus further includes a photoelectric converter (OEC) 500 of a charge coupled device (CCD) or a complementary metal oxide semiconductor (CMOS) (not shown) that converts light from the optical system OPS into electrical analog signals. In the present embodiment, the OEC 500 will often be referred to as CCD 500 as an example. It is to be understood, however, that the OEC 500 may also be implemented using CMOS.

The digital image processing apparatus further includes a digital signal processor (DSP) 507. Algorithms needed for the operation of the DSP 507 and for setting data are stored in an electrically erasable and programmable read-only memory (EEPROM) 505. The DSP 507 controls a timing circuit 502 to control the operation of the OEC 500 and an analog-to-digital converter (ADC) 501. The timing circuit 502 is controlled by the micro-controller 512. The ADC 501 converts the analog signals output from the OEC 500 into digital signals. The DSP 507 processes the digital signal from the ADC 501 and generates a digital image signal, which is divided into a chrominance signal and a luminance signal. The digital processing apparatus further includes a removable memory card coupled to a memory card interface (MCI) 506.

Referring still to FIG. 4, the digital image processing apparatus also has a light emitting unit LAMP, and a flash controller 511. The light emitting unit LAMP is operated by the micro controller 512 and includes the operate/self-timer lamp 11 (see FIG. 3), the automatic focus lamp 33 (see FIG. 3), and the flash standby lamp 34 (see FIG. 3). The flash 12 is operated via a flash controller 511 and the micro-controller 512 according to a signal from the FS 19.

The digital image processing apparatus further includes a user input unit INP. The user input INP includes the shutter 13 (see FIG. 2), the mode dial 14 (see FIG. 2), the function-select button 15 (see FIG. 2), the function-block button 18 (see FIG. 2), the monitor button 32 (see FIG. 3), the exposure compensation/delete button 36 (see FIG. 3), the enter/play button 37 (see FIG. 3), the menu/OK button 38 (see FIG. 3), the wide-angle zoom button 39w (see FIG. 3), the telephoto zoom button 39t (see FIG. 3), the up-movement button 40up (see FIG. 3), the right-movement button 40ri (see FIG. 3), the down-movement button 40lo (see FIG. 3), and the left-movement button 40le (see FIG. 3).

The digital image signal output from the DSP 507 is temporarily stored in a dynamic random access memory (DRAM) 504. In an embodiment of the invention, during the noise removal procedure, a preset number of image frames of a same image are photographed by the OEC 500 and are stored in the DRAM 504. The digital image signal output from the DSP 507 is also input to an LCD driving unit 514. As a result, an image is displayed on the display panel 35, that is, a displaying unit. The digital image signal output from the DSP 507 can also be transmitted serially via a universal serial bus (USB) connector 21a or an RS232C interface 508 and its connector 21b, or can be transmitted as video signals via a video filter 509 and a video outputting unit 21c.

Referring still to FIG. 4, the digital image processing apparatus further includes an audio processor 513, which outputs an audio signal from the microphone MIC to the DSP 507 or the speaker SP, and outputs an audio signal from the DSP 507 to the speaker SP.

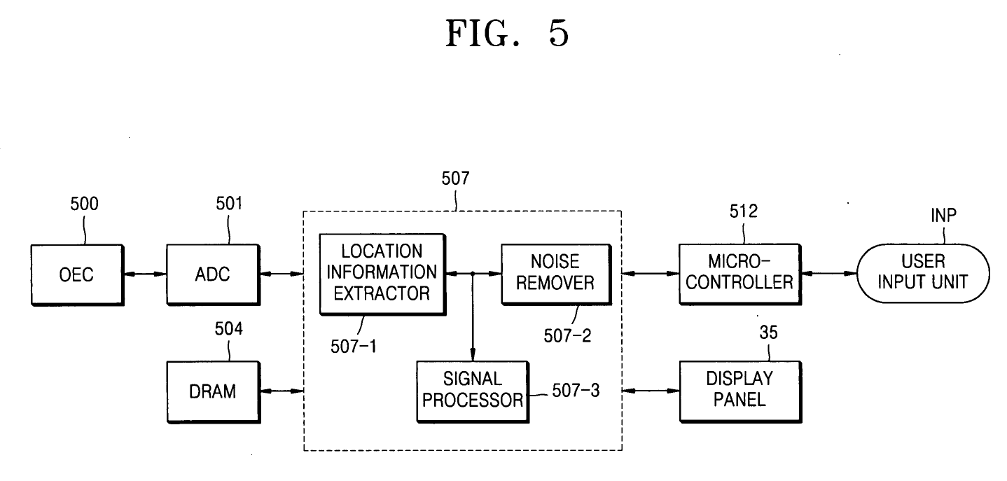

Referring to FIG. 5, a block diagram of an apparatus for removing fixed pattern noise in the digital camera according to an embodiment of the present invention is shown. Compared to a conventional apparatus for removing fixed pattern noise, the apparatus illustrated in FIG. 5 requires less time to photograph and image, and efficiently removes the fixed pattern noise. The apparatus includes the OEC 500, the ADC 501, the DRAM 504, the DSP 507, the micro-controller 512, the user input unit INP, and the display panel 35 (from FIG. 4). The DSP 507 includes a location information extractor 507-1, a noise remover 507-2, and a signal processor 507-3.

For example, the user user sets the sensitivity (ISO) and exposure time of the digital camera 1 via a menu provided by the micro-controller 512 and displayed on the display panel 35. In particular, the micro-controller 512 provides a menu for selecting a night scene photographing mode to set the exposure time. Thus, the user can arbitrarily set the exposure time by selecting the menu for the night scene photographing mode. In response to the user pressing the shutter butting, the digital camera 1 takes a photograph, which will be referred to as image frame Frame 1.

When the digital camera 1 takes the photograph, the OEC 500 converts incident light into electrical signals, and the ADC 501 converts the electrical signals into digital signals and stores the digital signals in the first region of the DRAM 504. In this example, it is assumed that image frame Frame 1 includes fixed pattern noise.

When the image frame Frame 1 is stored in the DRAM 504, the micro-controller 512 changes a setting of the digital camera 1 in preparation for taking a second photograph, which will be referred to as dark frame Frame 2. Specifically, the micro-controller 512 changes the ISO and the exposure time to photograph the dark frame Frame 2 and physically blocks all light from entering the OEC 500.

At this time, the micro-controller 512 sets the ISO of the digital camera 1 to be N times the ISO used to photograph the image frame Frame 1, and sets the exposure time of the digital camera 1 to be 1/N the exposure time used to photograph the image frame Frame 1. Here, N is a natural number.

For example, if the ISO used to photograph an image frame Frame 1 is 100, the ISO used to photograph a dark frame Frame 2 is set to 200, which is double the ISO used to photograph the image frame Frame 1. If the exposure time used to photograph the image frame Frame 1 is 16 seconds, the exposure time used to photograph the dark frame Frame 2 is set to 8 seconds, which is ½ the exposure time used to photograph the image frame Frame 1. The dark frame Frame 2 is then photographed and stored in the second region of the DRAM 504.

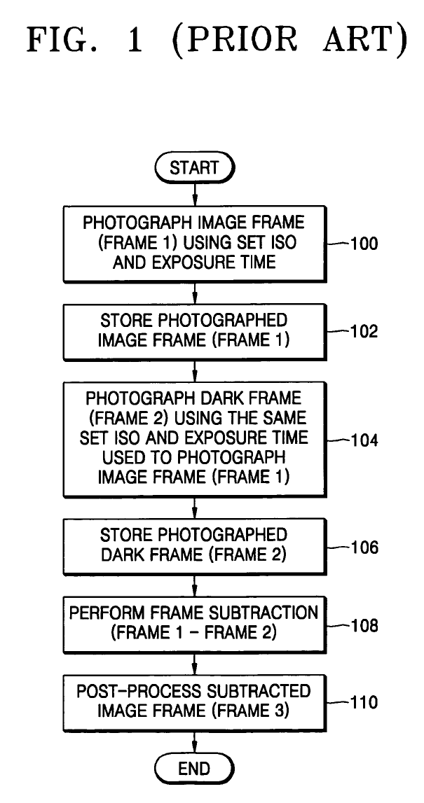

In the conventional method described above in conjunction with FIG. 1, the same exposure time used to photograph an image frame Frame 1 is also used to photograph a dark frame Frame 2, thereby producing the exact same fixed pattern noise created on both the image frame Frame 1 and the dark frame Frame 2. However, in the present embodiment, image frame Frame 2 is photographing using a different ISO and exposure time than that used to photograph image frame Frame 1.

Table 1 illustrates how, as the ISO of the digital camera 1 increases, the exposure time of the shutter 13 is proportionally decreased, the amount of fixed pattern noise created on the dark frame Frame 2 increases. The values in Table 1 were obtained experimentally.

TABLE 1

| Digital | Shutter Exposure | No. of Pixels of |
|---|---|---|
| camera ISO | Time (sec.) | Fixed Pattern Noise |
| 100 | 16 | 5990 |
| 200 | 8 | 7323 |
| 400 | 4 | 11094 |

The number of pixels of fixed pattern noise in Table 1 denotes the number of pixels having a value greater than a critical value (e.g., 10000) which indicates that the charges in a given pixel are a result of fixed pattern noise in the dark frame Frame 2 having a resolution of, for example, 2456×1760.

The dark frame Frame 2 is photographed with N times the ISO used to photograph the image frame Frame 1 and 1/N the exposure time used to photograph the image frame Frame 2. Therefore, the dark frame Frame 2 includes the fixed pattern noise included in the image frame Frame 1.

The location information extractor 507-1 of the DSP 507 extracts location information of the fixed pattern noise from the dark frame Frame 2 stored in the second region of the DRAM 504 and stores the extracted location information in the third region of the DRAM 504.

The noise remover 507-2 filters and removes the fixed pattern noise from the image frame Frame 1 stored in the first region using the location information of the fixed pattern noise stored in the third region of the DRAM 504.

The noise remover 507-2 uses, for example, a low frequency spatial filter to remove the fixed pattern noise. For example, the noise remover 507-2 can use a median filter which outputs a median value after comparing fixed pattern noise with adjacent pixel values.

The signal processor 507-3 performs image processing on a new image frame Frame 3 with the fixed pattern noise removed to improve the quality of the image. Then, the new image frame Frame 3 is stored in another region of the DRAM 504 or is displayed on the display panel 35.

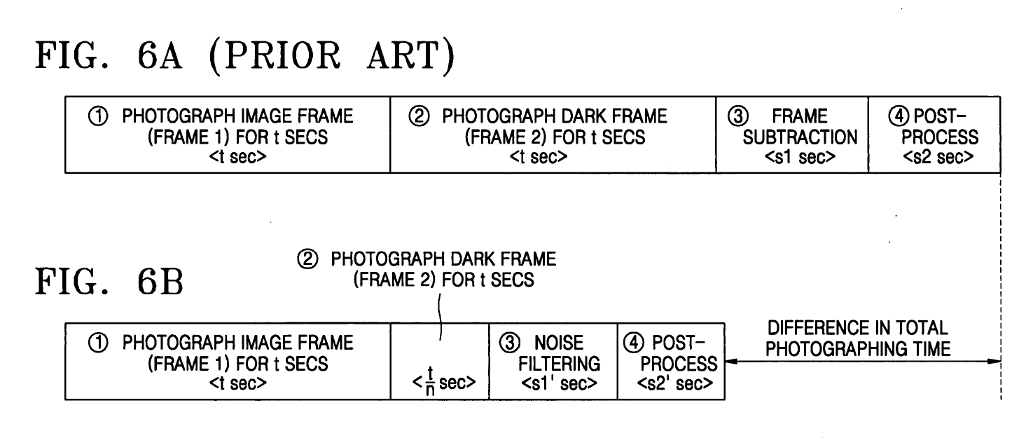

Referring to FIGS. 6A and 6B, a comparison of the total photographing time of a conventional digital camera and the total photographing time of digital camera 1 is shown. In a conventional method of removing fixed pattern noise using frame subtraction, the total photographing time is more than double the set exposure time of a digital camera. Thus, the photographing time increases. For example, referring to FIG. 6A, if an exposure time of 16 seconds is applied to a conventional digital camera, \textcircled{1} image frame (Frame 1) is photographed for 16 seconds, \textcircled{2} dark frame (Frame 2) is photographed for 16 seconds, \textcircled{3} noise is removed for s1 seconds, and \textcircled{4} post-processing is performed for s2 seconds. Consequently, the total photographing time (\textcircled{1}+\textcircled{2}+\textcircled{3}+\textcircled{4}) is more than double the exposure time, that is, 32+s1+s2 seconds.

However, in the present embodiment of the present invention, the time to photograph the dark frame Frame 2 is shorter than the time to photograph the image frame Frame 1 (e.g., when quadrupling the ISO, ¼ the exposure time is used), thereby reducing the total photographing time. For example, referring to FIG. 6B, if an exposure time of 16 seconds used, \textcircled{1} the image frame Frame 1 is photographed for 16 seconds, \textcircled{2} the dark frame Frame 2 is photographed for 4 seconds, \textcircled{3} noise is removed for s'1 seconds, and \textcircled{4} post-processing is performed for s'2 seconds. Consequently, the total photographing time (\textcircled{1}+\textcircled{2}+\textcircled{3}+\textcircled{4}) takes 20+s'1+s'2 seconds, which is less than the total photographing time of the conventional method.

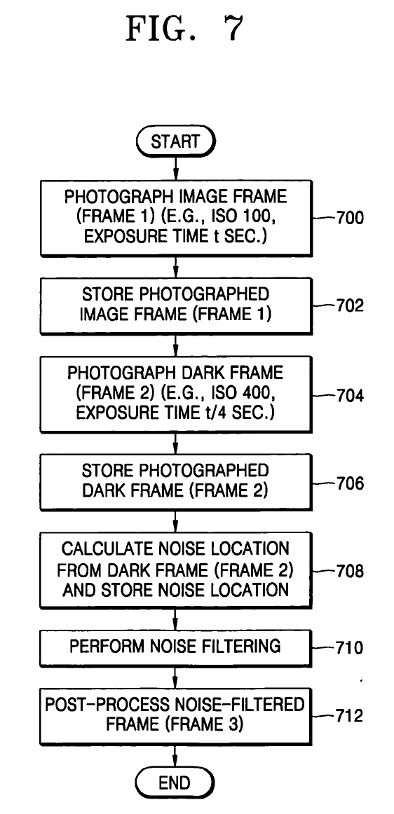

Referring now to FIG. 7, a method of removing the fixed pattern noise in the digital camera 1 according to an embodiment of the invention will now be described. First, an image frame Frame 1 is photographed using a set ISO and exposure time (700). For example, the ISO is set to 100 and the exposure time is set to 16 seconds and the image frame Frame 1 is photographed. The OEC 500 converts incident light into electrical signals, and the ADC 501 converts the electrical signals into digital signals.

The image frame Frame 1, which is digitalized and includes fixed pattern noise, is stored in the first region of the DRAM 504 (702). Then, the micro-controller 512 changes the ISO and the exposure time set in the digital camera 1 and photographs a dark frame Frame 2 while physically blocking all incident light (704). The micro-controller 512 sets the ISO to be N times the ISO used to photograph the image frame Frame 1 and sets the exposure time to be 1/N the exposure time used to photograph the image frame Frame 1. Here, N is an arbitrary natural number. For example, if the ISO is 100 when photographing the image frame Frame 1, the ISO use to photograph the dark frame Frame 2 can be quadrupled to 400, and if the exposure time is 16 seconds when photographing the image frame Frame 1, the exposure time used to photograph the dark frame Frame 2 is set to ¼ the exposure time used to photograph the image frame Frame 1, that is, 4 seconds. The photographed dark frame Frame 2 is stored in the second region of the DRAM 504 (706).

As illustrated in Table 1, the number of hot pixels producing the fixed pattern noise in the dark frame Frame 2 increases as the ISO of the digital camera 1 increases and the exposure time of the digital camera 1 decreases. Since the dark frame Frame 2 is photographed with N times the ISO used to photograph the image frame Frame 1 and 1/N the exposure time used to photograph the image frame Frame 1, the dark frame Frame 2 includes the fixed pattern noise included in the image frame Frame 1.

The location information extractor 507-1 extracts location information of the fixed pattern noise from the dark frame Frame 2 stored in the second region of the DRAM 504 and stores the location information in the third region of the DRAM 504. (708).

The noise remover 507-2 filters and removes the fixed pattern noise of the image frame Frame 1 stored in the first region of the DRAM 504 using the location information of the fixed pattern noise stored in the third region of the DRAM 504 (710).

A low frequency spatial filter such as a median filter is used to remove the fixed pattern noise of the image frame Frame 1 to define a new image Frame 3, from which the fixed pattern noise is absent. In doing so, the median filter outputs a median value by comparing the fixed pattern noise and adjacent pixel values.

The signal processor 507-3 performs image processing on the new image frame Frame 3 to improve the quality of an image. Then, the signal processor 507-3 stores the new image frame Frame 3 in another region of the DRAM 504 or displays it on the display panel 35 (712).

As illustrated in FIG. 6, the total photographing time is shortened remarkably in the present embodiment compared to the conventional method since the exposure time used to photograph the dark frame Frame 2 is 1/N the exposure time used to photograph the image frame Frame 1.

As described above, an embodiment of the present invention photographs a dark image by increasing ISO and reducing exposure time of a digital camera compared to those used when photographing an original image. Location information of fixed pattern noise is extracted from the photographed dark image to remove the fixed pattern noise from the original image. Thus, the fixed pattern noise can be effectively removed while reducing the total photographing time.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for removing fixed pattern noise in a digital camera, the apparatus comprising:
a signal processing unit that performs steps comprising:
receiving signals representing a first photograph, wherein the first photograph was taken at first ISO and at a first exposure time, and wherein the first photograph includes fixed pattern noise;
receiving signals representing a second photograph, wherein the second photograph was taken in the absence of light at a second ISO and at a second exposure time, the second ISO being different from the first ISO, the second exposure time being different from the first exposure time;
analyzing the second photograph;
calculating the location of the fixed pattern noise based on the analyzing step; and
removing the fixed pattern noise from the first photograph using the calculated location.

2. The apparatus of claim 1, wherein the second ISO is N times the first ISO, and the second exposure time is 1/N times the first exposure time.

3. The apparatus of claim 2, wherein the signal processing unit comprises:
a location information extractor that extracts the location information of the fixed pattern noise from the second photograph;
a noise remover that filters the fixed pattern noise from the first photograph using the location information; and
a signal processor that processes the first photograph to remove the fixed pattern noise thereby resulting in an image that is displayable.

4. The apparatus of claim 1, further comprising a storage unit, wherein the storage unit includes:
a first region to store the first photograph;
a second region to store the second photograph; and
a third region to store the calculated location information.

5. The apparatus of claim 1, further comprising:
a lens; and
a photoelectric converter, wherein the photoelectric converter performs steps comprising:
receives light through the lens to capture an image for the first photograph;
receives no light through the lens to capture an image for the second photograph;
converts the captured image for the first photograph and the captured image for the second photograph into the signals; and
transmits the signals to the signal processing unit.

6. The apparatus of claim 5, wherein the photoelectric converter is a charge-coupled device.

7. The apparatus of claim 5, wherein the photoelectric converter is a complimentary metal oxide semiconductor device.

8. The apparatus of claim 5, further comprising:
a shutter that performs steps comprising:
opening to permit the light to reach the photoelectric converter to enable the photoelectric converter to capture the image for the first photograph;
closing to prevent the light from reaching the photoelectric converter to enable the photoelectric converter to capture the image for the second photograph,
wherein the first image and the second image each have the fixed pattern noise in the same respective locations.

9. The apparatus of claim 1, further comprising:
a user input unit that receives a user input of the first ISO and the first exposure time, wherein the signal processing unit sets the second ISO and the second exposure time based on a function of the first ISO and first exposure time.

10. The apparatus of claim 1, further comprising:
a display that displays the first photograph after the fixed noise has been removed by the signal processing unit.

11. A method of removing fixed pattern noise in a digital camera, the method comprising:
photographing a main image using a first ISO and a first exposure time;
photographing a dark image using a second ISO and a second exposure time, wherein the second ISO is different from the first ISO, and the second exposure time is different from the first exposure time;
determining the location of the fixed pattern noise in the dark image; and
using the determined location to remove the fixed pattern noise from the general image.

12. The method of claim 11, wherein the second ISO is equal to a value that is about N times the first ISO, and wherein the second exposure time is equal to a value that is about the first exposure time divided by N.

13. The method of claim 12, wherein N is a number that is greater than 1.

14. The method of claim 11, further comprising:
opening a shutter of the digital camera to permit a photosensitive device of the digital camera to receive light;
photographing the main image with the received light, wherein the main image contains the fixed pattern noise;
closing the shutter to prevent the photosensitive device from receiving the light; and
photographing the dark image while the shutter is closed, wherein the dark image contains fixed pattern noise at the same location on the dark image as the location at which the fixed pattern noise appeared in the main image.

15. The method of claim 14, wherein the second ISO is equal to a value that is about N times the first ISO, and wherein the second exposure time is equal to a value that is about the first exposure time divided by N.

16. The method of claim 11, further comprising:
displaying the main image on a display panel of the digital camera after the using step.

17. The method of claim 11, further comprising:
after the using step, storing, in a memory of the digital camera, the main image; and
in response to a user input to the digital camera, retrieving the main image from the memory and displaying it to the user on a display panel of the digital camera.

18. The method of claim 17, wherein the display panel is integrated into a housing of the digital camera, and wherein the memory is located within the housing.

19. The method of claim 11, further comprising:
receiving, from a user via a user input unit of the digital camera, a value for the first ISO and a value for the first exposure time; and
calculating the second ISO and the second exposure time without any further input from the user.

20. A method for removing fixed pattern noise, the method comprising:
setting the digital camera to a first ISO and a first exposure time;
opening a shutter of a digital camera to permit light to enter the digital camera;
receiving the light with a charge-coupled device;
capturing a first image with the charge-coupled device;
setting the digital camera to a second ISO and a second exposure time;
closing the shutter to prevent light from entering the digital camera;
capturing a second image with the charge-coupled device while the shutter is closed;
determining, using a digital signal processor, the location of the fixed pattern noise on the second image;
altering the content of the first image at a location on the first image that matches the determined location on the second image, thereby removing the fixed pattern noise from the first image; and
displaying the altered content of the first image on a display panel.
